(19) United States
(12) Patent Application Publication
(10) Pub. No.: US 2010/0004950 A1
(43) Pub. Date: Jan. 7, 2010

(54) SYSTEM AND METHOD FOR USAGE OF PERSONAL MEDICAL RECORDS IN MOBILE DEVICES

(75) Inventors: Gabor Bajko, Mountain View, CA (US); Krisztian Kiss, San Francisco, CA (US)

Correspondence Address: FOLEY & LARDNER LLP, P.O. BOX 80278, SAN DIEGO, CA, 92138-0278, US

(73) Assignee: Nokia Corporation

(21) Appl. No.: 12/168,011

(22) Filed: Jul. 3, 2008

(51) Int. Cl. G06Q 50/00

(52) U.S. Cl. 705/3

(57) ABSTRACT

A document containing medical-related information is created and stored on, e.g., a mobile device. The document can then be transmitted from the mobile device to an appropriate servicing entity, such as a public safety answering point (PSAP) when an emergency call is made, allowing the PSAP to receive pertinent information about an emergency caller. Additionally, the document can be transmitted to, e.g., an appropriate near field communication (NFC) reader/receiver so that, e.g., a patient may automatically transfer information that is conventionally gathered by the patient completing a plurality of complex forms. Further still, various embodiments can enable the querying/transmitting of medical-related information over hypertext transfer protocol (HTTP) so that online questionnaires may be completed and responses received directly for users wishing to purchase medication online.

### FIELD OF THE INVENTION

Various embodiments relate generally to the usage of personal information. More particularly, various embodiments allow for the transmission of an extensible markup language (XML) document with medical-related information on, e.g., a mobile device, to appropriate entities.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

With the use of the Internet becoming more widespread, the Internet Protocol (IP) is being utilized more often as a basis for communication systems and technologies. That is, IP communication devices such as IP phones are replacing the use of traditional telephones operating, e.g., within the Plain Old Telephone System (POTS) environment. Additionally and as the use of mobile devices becomes more widespread, systems and technologies based on wireline systems are being adapted, integrated with, or replaced with wireless communication systems and technologies. Therefore, traditional services, e.g., emergency services, are also being adapted, integrated with, and/or replaced with IP-based and/or wireless systems and technologies which must address issues regarding, for example, location determination and call processing over these IP and/or wireless networks.

For example, the Internet Engineering Task Force (IETF) and other standards organizations have endeavored to standardize various aspects of emergency calling over IP networks. One such working group in the IETF is referred to as Emergency Context Resolution with Internet Technologies (ECRIT). Traditional emergency systems utilize, e.g., the public switched telephone network (PSTN), to recognize special numbers such as “911” or “311” as being indicative of a request for emergency or special services. Such calls are delivered to specialized call centers, e.g., public safety answering points (PSAPs), which can process and/or handle the calls by dispatching appropriate police or fire personnel, for example. In order for emergency services to be successfully delivered, these traditional systems are based on an association of the physical location of a calling party and, e.g., the nearest appropriate PSAP.

In contrast, emergency calls placed using Internet technologies do not have the same systems available and commonly resort to overlay networks and tunnels. Hence, ECRIT is working towards standardizing location and call routing management for emergency calls within the Internet environment. However, provisions for the delivery of information that may be deemed useful in emergency situations, such as a caller's medical history/information, have yet to be made.

Various use case scenarios involving the gathering of medical information require involved methods of requesting and receiving the desired medical information. For example, when an ambulance is called for an emergency using a mobile device, current IP-based solutions as described in the IETF ECRIT specifications do not include data about pre-existing medical conditions of a caller. The knowledge of such pre-existing condition may prove critical to saving lives, and hence conventional PSAPs attempt to identify a caller and then access a medical insurance database to download this medical-related information. However, many variables can affect the retrieval of this information at a PSAP. For example, the medical insurance company of the caller may not be known, the caller may not reside in the particular country from where they are placing the emergency call, etc.

Another use case scenario may involve the necessity for a new medical patient to complete medical history forms when first visiting a medical service provider. Conventionally, new patients are required to list, e.g., known medical conditions, insurance information, personal data, etc. on a plurality of forms that can take an inordinate amount of time to complete. Further still, it is common for purchasers of medicine online to be asked questions regarding allergies, pre-medication, medical history, etc.

### SUMMARY OF THE INVENTION

In accordance with various embodiments, a document, such as an XML document, containing personal information such as medical-related information is created. For example, a mobile device user interface may be utilized to ask questions regarding information about a user's pre-existing medical condition(s), such as past surgeries, allergies, chronic diseases, etc. Based upon the responses to the questions, a medical records XML document is created and stored at the mobile device where it was created. The XML document can then be transmitted from the mobile device to an appropriate entity, such as a PSAP, when an emergency call is made. Thus, the PSAP is able to receive pertinent information about an emergency caller at the time of an emergency call. Additionally, the XML document can be transmitted to an appropriate near field communication reader/receiver at a doctor's office so that, for example, a patient may automatically transfer information that is conventionally gathered by the patient completing a plurality of complex forms. Alternatively, the XML document can be transmitted to an online appointment scheduling entity/application utilized by the doctor's office. Further still, various embodiments enable the querying/transmitting of medical-related information over hypertext transfer protocol so that online questionnaires may be completed and responses received directly for users wishing to purchase medication online.

These and other advantages and features of various embodiments of the present invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

Embodiments of the invention are described by referring to the attached drawings, in which:

FIG. 1 is an overview diagram of a system within which various embodiments of the present invention may be implemented;

FIG. 2 is a perspective view of an electronic device that can be used in conjunction with the implementation of various embodiments of the present invention;

FIG. 3 is a schematic representation of the circuitry which may be included in the electronic device of FIG. 2;

FIG. 4 is a graphical representation of possible interactions within an exemplary emergency services architecture in accordance with various embodiments; and

FIG. 5 is a flow chart illustrating processes performed in accordance with various embodiments.

### DETAILED DESCRIPTION OF VARIOUS EMBODIMENTS

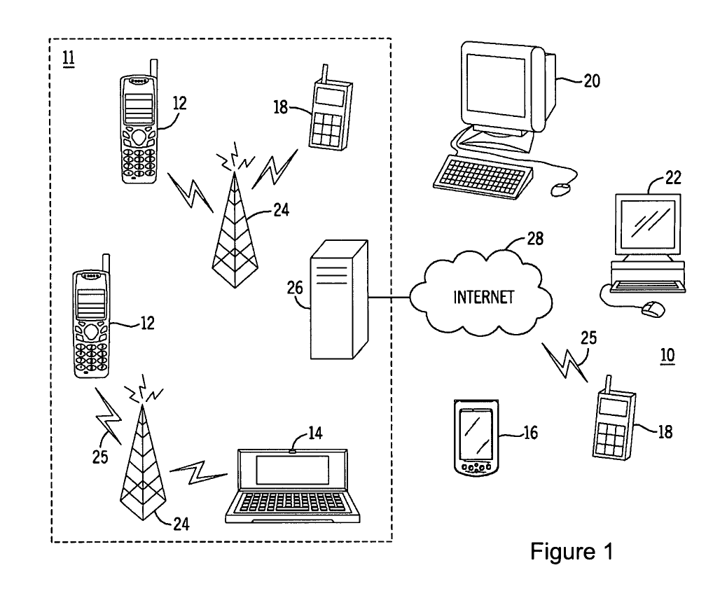

FIG. 1 shows a system 10 in which various embodiments of the present invention can be utilized, comprising multiple communication devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 1 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, an electronic device 12 in the form of a mobile telephone, a combination personal digital assistant (PDA) and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

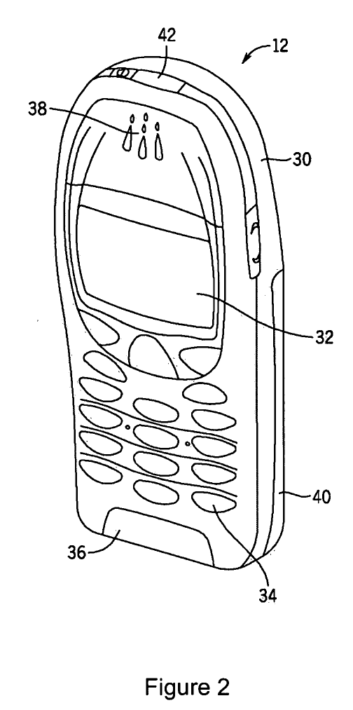

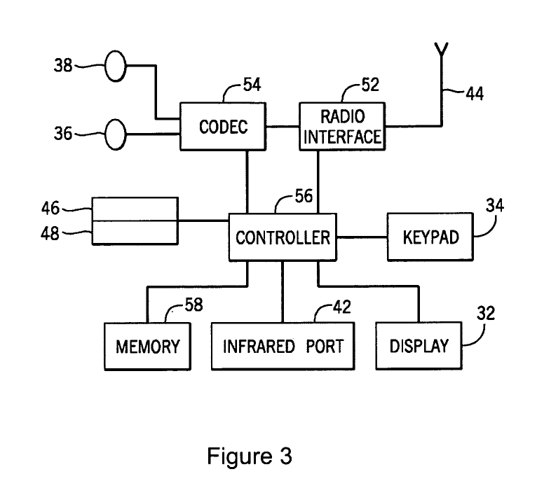

FIGS. 2 and 3 show one representative electronic device 12 within which the present invention may be implemented. It should be understood, however, that the present invention is not intended to be limited to one particular type of device. The electronic device 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. Individual circuits and elements are all of a type well known in the art.

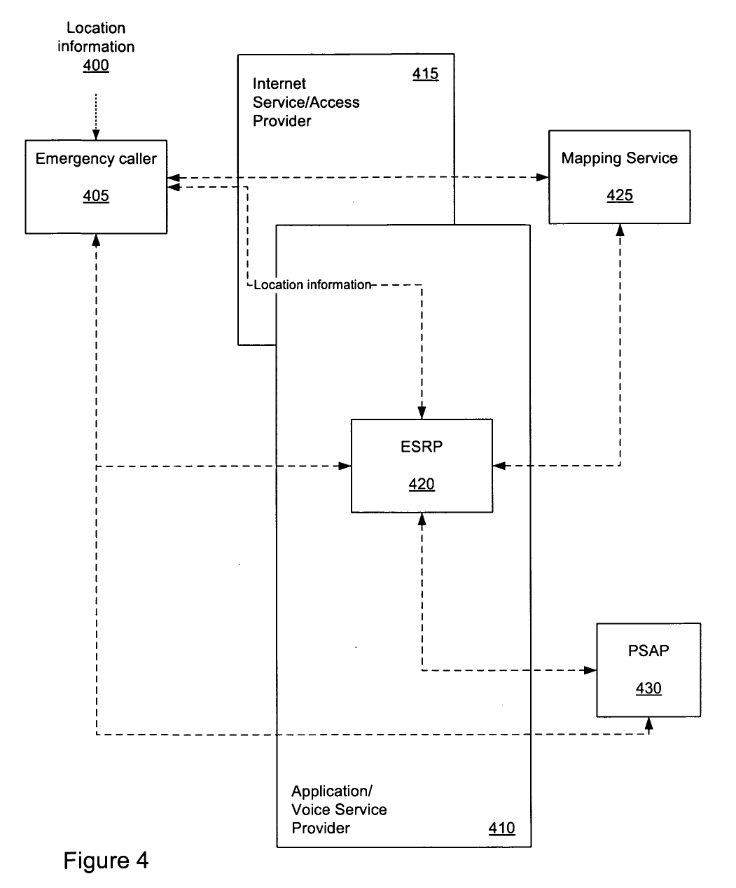

FIG. 4 illustrates entities of an exemplary emergency services architecture in accordance with various embodiments. It should be noted that various methods of deployment are possible with such an architecture. For example, the overlapping architecture in FIG. 4 indicates that certain functions can be handled by a single entity. That is, an Application/Voice Service Provider (ASP/VSP) 410 may be implemented separately or in conjunction with an Internet Service/Access Provider 415. The ASP/VSP 410 can refer to an entity or service provider that provides application-layer and/or voice services based on IP, e.g., call routing, Session Initiation Protocol (SIP) Uniform Resource Indicator (URI), or PSTN termination. The Internet Service/Access Provider 415 can refer to an organization that provides one or more of physical and data link network connectivity to users, as well as IP network layer services. Additionally, end systems might act as their own ASP/VSP 410, e.g., either for enterprises or for residential users. However, ASPs/VSPs are typically not able to directly determine the physical location of an emergency caller 405, where the emergency caller 405 refers to a person or entity placing an emergency call of sending an emergency instant message (IM).

Various potential interactions between the entities depicted in FIG. 4 are described herein. Location information 400 might be available to an end host/servicing entity itself, such as PSAP 430, where the PSAP 430 refers to a facility for receiving emergency calls under the responsibility of, e.g., a public authority. Alternatively, location information may be obtained from the Internet Service/Access Provider 415 via an Emergency Service Routing Proxy (ESRP) 420. The ESRP refers to a support entity for invoking a location-to-PSAP URI mapping function that will return an appropriate PSAP URI or alternative ESRP URI to identify the proper PSAP/ESRP to route an emergency call. Alternatively still, an emergency caller 405 may consult a Mapping Service 425 to determine an appropriate PSAP 430 (or other relevant information) that is appropriate for the physical location of the emergency caller 405. Moreover, other attributes may be considered including, e.g., appropriate language support by an emergency call taker (not shown).

Location information 400 is used by emergency call routing support entities for subsequent mapping requests. Hence, emergency call routing support entities such as the ESRP 420 may also consult the Mapping Service 425 to determine where to route the emergency call. For infrastructure-based emergency call routing (contrasted with user equipment (UE)-based emergency call routing), the ESRP 420 would forward the emergency call to the PSAP 430.

As described above, conventional IP-based emergency systems do not provide the ability to transmit personal information such as an emergency caller's (e.g., the emergency caller 405) medical information to appropriate entities, such as the PSAP 430. In accordance with a first use case scenario, various embodiments allow for such information to be provided to the PSAP 430 from a mobile device (e.g., mobile telephone) utilized by the emergency caller 405 to make an emergency call (as for example, on the path indicated by the dotted line between the PSAP 430 and the emergency caller 405). Doing so eases the burden on the PSAP 430 to identify the caller and negates a need to access, e.g., a medical insurance database which can present its own issues including communication delays, resource availability, etc. Additionally and in accordance with a second use case scenario, various embodiments enable a mobile device to transfer a user's medical information to a local doctor's office system automatically. For example., upon entering the doctor's office, at a time when an appointment is being scheduled/booked, etc., the user's medical information may be transferred using, e.g., using “near field communication” (NFC). Alternatively, some other short-range communication mode may be utilized, e.g., Bluetooth. Moreover and with regard to a third use case scenario, various embodiments make the online purchase of medicine more efficient and a more user-friendly experience. For example, a mobile and/or electronic device on behalf of a user would be able to automatically provide information regarding questions about, e.g., the user's medical data on a mobile device making it possible to answer those questions automatically as described in greater detail below. Thus, the user may only need to give access authorization to an online medicine seller's purchasing application and could receive an instantaneous response as to whether or not a desired medicine would be appropriate for him/her without the need to respond to each question separately. That is, an online pharmacy/medicine seller's application would ask questions regarding, e.g., a user's medical history, and in accordance with various embodiments, the user's electronic and/or mobile device would, on the user's behalf, be able to provide information regarding the questions automatically.

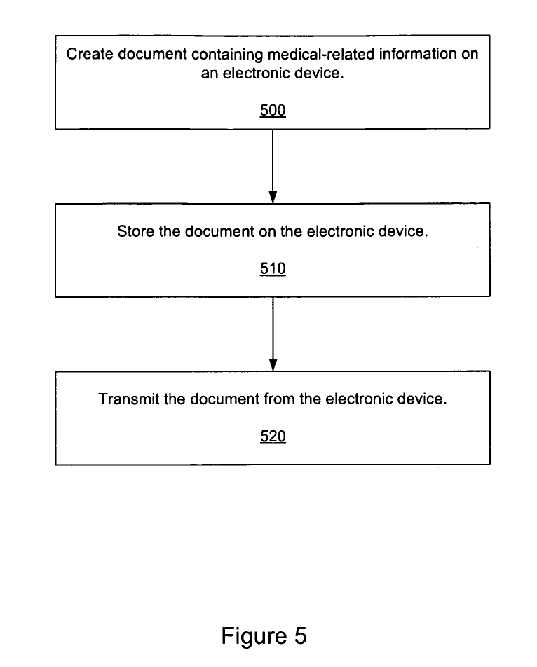

FIG. 5 is a flow chart illustrating various processes performed in accordance with various embodiments. At 500, a document containing personal information such as medical-related information is created at an electronic device, such as a mobile device/IP-based electronic device. To accomplish creation of the document, a user interface may be created and utilized which asks questions regarding, e.g., basic information about a user's pre-existing medical condition(s), such as past surgeries, allergies, chronic diseases, etc. Based upon the responses to the questions, a medical records document is created. At 510, the document is stored at the electronic device where it was created. At 520, the document is transmitted from the electronic device to an appropriate servicing entity, such as a PSAP, a doctor's office, an online provider of medical service(s)/medication, etc. It should be noted that the created and stored medical records document may be implemented using a variety of different document types. That is, different document types including various XML schemas can be utilized in conjunction with various embodiments as long as the document types utilized are able to store the requisite information. Various embodiments are not dependent upon, e.g., conventional comprehensive and/or complex document schemas, but may rather utilize simpler schemas that, again, are capable of storing the requisite data. It should be further noted that a servicing entity should be able to receive the medical records document in the same format that it was created and stored in.

Emergency calls can be made by dialing special digits, such as “9-1-1,” from a telephony device such as a mobile telephone. In accordance with the specification documents promulgated by the IETF ECRIT working group, a service Uniform Resource Name (URN) is utilized to convey information about a desired service to certain network entities. For example, an IP telephone may be used to invoke emergency service by including a service URN in an outgoing SIP message. The service URN is translated into a routable URI for a location-appropriate service provider such as a SIP URL associated with an appropriate PSAP. Different types of emergency services are available and different service URNs may be sent in a SIP message. Thus, service URNs are registered with the Internet Assigned Numbers Authority (IANA). For example, “urn:service:sos” is one such service URN which refers to a generic “sos” service that reaches a PSAP, which in turn dispatches the appropriate assistance/resources to an emergency. The sos services can further encompass more specific service URNs, such as “urn:service:sos.ambulance,” “urn:service:sos.physician,” etc. When a service URN, such as urn:service:sos.ambulance reaches an ambulance service, an ambulance for providing emergency medical services will be dispatched to the location of an emergency.

In accordance with the first use case scenario described above, various embodiments transmit a medical records XML document to a PSAP along with an emergency call. That is, a urn:service:sos.ambulance service URN is placed using SIP and the procedures described above, where the medical records XML document may be placed in the body of a SIP INVITE request targeted to the PSAP. This INVITE body transports at least some of the medical records data about, e.g., pre-existing medical conditions of a caller, to the PSAP and would be interpreted accordingly by the PSAP. If the receiving PSAP does not understand this extension to the INVITE body, the medical records XML document/content can be ignored by the PSAP.

Moreover, in order to include XML content like the medical records information in the body of an INVITE request (or other appropriate SIP requests as is also contemplated herein) a Multipurpose Internet Mail Extension (MIME) type can be registered for definition within a SIP context. For example, the MIME type can be “application/medical-record+xml” if registered in IETF (IANA) through the standards track RFC process. Alternatively, a MIME type “application/vnd.3GPP.medical-record+xml” can be registered elsewhere, such as with another standards organization (e.g. 3GPP shown in this example). This MIME type can be utilized to describe the XML content captured within the medical records XML document.

Alternatively still, an option-tag can be defined to indicate support for transferring the medical records XML document and be included in the Supported header field, “Supported: medical-record.” It should be noted however, that various embodiments may utilize a plurality of different delivery methods for sending medical records XML documents to a PSAP at the time of an emergency call.

With regard to the second use case scenario described above, various embodiments enable the sending of a medical records XML document over hypertext transfer protocol (HTTP) because online appointment requests are generally made using a web browser. In order to transmit the medical records XML document over HTTP, the MIME type described above can be used in this use case scenario to include XML content in HTTP messages. The medical records XML document can also be transferred directly using NFC/short-range communication methods, such as via a contactless card, radio-frequency identification (RFID), Bluetooth, or other appropriate transfer techniques. Alternatively, the medical records XML document can be transferred to another device associated with the user. That is, at least a portion of the XML content within the medical records XML document can be transferred to an appropriate reader/receiver when a user is in, e.g., a doctor's office, and within NFC communication range with the reader/receiver. The transfer can be accomplished using, e.g., the user's mobile device which can employ NFC, or a stand-alone NFC device.

As to the third use case scenario described above, the XCAP protocol as specified in the IETF RFC4825 document available at http://www.ietf.org/rfc/rfc4825.txt can be used to query/provide particular elements or attributes within the XML content of the medical records XML document. XCAP refers to a protocol that allows for the reading, writing, and modifying of application configuration data stored in XML format on a server. XCAP describes a convention for describing elements and attributes of an XML document as an HTTP resource, i.e., accessible via an HTTP URI. Additionally, XCAP describes a technique for using HTTP GET, PUT and DELETE methods for various document manipulation operations (e.g., retrieving/adding/deleting elements/attributes, etc.). Furthermore, XCAP can describe the concept and structure of an Application Usage by which XML documents can be described.

In accordance with various embodiments, a well-defined XML document schema can be used to describe medical records or other personal data as described above, where an XML document is stored on a mobile phone. In order to manipulate this XML document via XCAP, a new XCAP Application Usage is created as required by RFC4825 in order to describe various properties of the XML document. Various properties of the XML document can include, but are not limited to the following: XML Schema; Default Document Namespace; MIME Type; Validation Constraints; Data Semantics; Naming Conventions; Resource Interdependencies; and Authorization Policies. An online pharmacy/medicine seller (or any other entity which needs access to the XML file storing medical records) can implement this Application Usage for accessing (retrieving) particular elements from the XML document from the mobile phone after the mobile phone initiates a transaction with the online pharmacy/medicine seller. The online pharmacy/medicine seller acts as an XCAP client while the mobile phone acts as XCAP server. The online pharmacy/medicine seller is aware of the XML document structure (schema) since it implements the Application Usage, and hence knows how to create an appropriate HTTP URI to address a particular XML element(s) or attribute(s) within the XML document in order to retrieve it.

The XCAP server (mobile device/phone) sets up appropriate authorization rules in order to allow the online pharmacy/medicine seller to retrieve elements so that the mobile phone is in full control what kind of information can be given away to the online pharmacy/medicine seller.

It should be noted that certain entities, may be authorized to update or otherwise manipulate the information, e.g., medical insurance companies, doctors, dentists, etc., while online pharmacies/medicine sellers may not. Alternatively, information such as medical records can be periodically synchronized with medical records kept for example, at a doctor's database.

Alternatively, a corresponding SIP mechanism (e.g., subscription to a SIP event package) such as that specified in the draft-ietf-simple-xcap-diff-09 document available at http://www.ietf.org/internet-drafts/draft-ietf-simple-xcap-diff-09.txt can also be used to query particular aspects (e.g., elements or attributes) within the medical records XML document. The online medicine seller sends a SUBSCRIBE request addressing the XML elements/attributes being monitored, and the mobile phone sends the requested data in the body of the NOTIFY request. It should be noted that in accordance with various embodiments, only other applications are of concern for, e.g., the second and third use case scenarios described above, where no third party application will be able to overwrite the data/information contained in the XML document that is stored on a device.

Although various embodiments have been described within the context of certain use case scenarios, the application and/or implement of various embodiments are not limited to only these use case scenarios. For example, in addition to or instead of medical-related information being created, stored, and transferred, various embodiments may be implemented using other personal information beyond conventional “user-credential” type data. Such personal information can include, but is not limited to a user's social security number, driver license number, emergency contact information, travel documentation, e.g., passport information, etc. That is, passport detail information could be stored on a mobile phone and utilized during electronic check-in at airports, and emergency contact information can be easily and quickly obtained to enable the emergency contact of a user involved in, e.g., an accident to be reached. Additionally, personal information such as a user's social security number and/or driver's license number can be, e.g., automatically provided to an online website without requiring the user to manually type in this information him/herself. It should further be noted that, although not necessary, certain use case scenarios described and/or contemplated herein are situations where the personal/medical-related information stored on an electronic device is associated with the owner of the electronic device. Alternatively, given the nature of personal/medical-related information stored on the electronic device, a user of the electronic device that is not also the owner thereof, may be given consent to utilize the electronic device, e.g., on behalf of the owner of the electronic device.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Various embodiments may be implemented in software, hardware, application logic or a combination of software, hardware and application logic. The software, application logic and/or hardware may reside, for example, on a chipset, a mobile device, a desktop, a laptop or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

Individual and specific structures described in the foregoing examples should be understood as constituting representative structure of means for performing specific functions described in the following the claims, although limitations in the claims should not be interpreted as constituting “means plus function” limitations in the event that the term “means” is not used therein. Additionally, the use of the term “step” in the foregoing description should not be used to construe any specific limitation in the claims as constituting a “step plus function” limitation. To the extent that individual references, including issued patents, patent applications, and non-patent publications, are described or otherwise mentioned herein, such references are not intended and should not be interpreted as limiting the scope of the following claims.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method, comprising:
creating a document containing medical-related information on an electronic device;
storing the document at the electronic device; and
transmitting the document from the electronic device.

2. The method of claim 1, further comprising storing, in addition to or instead of the medical-related information, personal information associated with a user of the electronic device, wherein the personal information includes non-credentials information to be transmitted in the document to a relevant entity, and wherein the electronic device comprises a mobile device.

3. The method of claim 2, wherein the relevant entity comprises at least one of an airport, an online website, and servicing personnel capable of utilizing the non-credentials information.

4. The method of claim 1, wherein the document is transmitted to a servicing entity over internet protocol during routing of an emergency call.

5. The method of claim 4, wherein the servicing entity comprises a public safety answer point.

6. The method of claim 4, wherein the document is placed as an extension into the body of a session initiation protocol INVITE request targeted to the servicing entity.

7. The method of claim 6, wherein the servicing entity ignores the document if the servicing entity does not recognize the extension.

8. The method of claim 6, wherein content of the document is described by a multipurpose internet mail extension type.

9. The method of claim 4, wherein the support for the document is indicated to the servicing entity via a session initiation protocol header field.

10. The method of claim 1, wherein the transmitting of the document occurs over hypertext transfer protocol during online scheduling of a medical appointment.

11. The method of claim 10, wherein content of the document is described by a multipurpose internet mail extension type.

12. The method of claim 1, wherein the transmitting of the document occurs using near field communication or short-range communication to a servicing entity or another device associated with a user of the electronic device.

13. The method of claim 1, further comprising initiating a transaction with an online pharmacy website, wherein the electronic device operates as an extensible markup language configuration access protocol server and the online pharmacy website operates as an extensible markup language configuration access protocol client.

14. The method of claim 13, further comprising retrieval of at least an element or an attribute of the document by the online pharmacy website via implementation of an extensible markup language configuration access protocol application usage at the online pharmacy website.

15. The method of claim 1, further comprising initiating a transaction with an online pharmacy website, wherein the online pharmacy website sends a session initiation protocol SUBSCRIBE request to the electronic device addressing at least one of an element or attribute of the document being monitored.

16. The method of claim 15, further comprising sending the at least one of the element or attribute to the online pharmacy website in a session initiation protocol NOTIFY request.

17. The method of claim 1, further comprising periodically synchronizing the document with medical-related information stored with an authorized servicing entity.

18. The method of claim 1, wherein the document comprises an extensible markup language document.

19. A computer program product, embodied on a computer-readable medium, comprising computer code configured to perform the processes of claim 1.

20. An apparatus, comprising:
an electronic device configured to:
create a document containing medical-related information;
store the document; and
transmit the document.

21. The apparatus of claim 20, wherein the electronic device is further configured to store, in addition to or instead of the medical-related information, personal information associated with a user of the electronic device, wherein the personal information includes non-credentials information to be transmitted in the document to a relevant entity, and wherein the electronic device comprises a mobile device.

22. The apparatus of claim 21, wherein the relevant entity comprises at least one of an airport, an online website, and servicing personnel capable of utilizing the non-credentials information.

23. The apparatus of claim 20, wherein the document is transmitted to a servicing entity over internet protocol during routing of an emergency call.

24. The apparatus of claim 23, wherein the servicing entity comprises a public safety answer point.

25. The apparatus of claim 23, wherein the document is placed as an extension into the body of a session initiation protocol INVITE request targeted to the servicing entity.

26. The apparatus of claim 25, wherein the servicing entity ignores the document if the servicing entity does not recognize the extension.

27. The apparatus of claim 25, wherein content of the document is described by a multipurpose internet mail extension type.

28. The apparatus of claim 23, wherein support for the document is indicated to the servicing entity via a session initiation protocol header field.

29. The apparatus of claim 20, wherein the is transmitted over hypertext transfer protocol during online scheduling of a medical appointment.

30. The apparatus of claim 29, wherein content of the document is described by a multipurpose internet mail extension type.

31. The apparatus of claim 20, wherein the document is transmitted using near field communication or short-range communication to a servicing entity or another device associated with a user of the electronic device.

32. The apparatus of claim 20, further comprising initiating a transaction with an online pharmacy website, wherein the electronic device operates as an extensible markup language configuration access protocol server and the online pharmacy website operates as an extensible markup language configuration access protocol client.

33. The apparatus of claim 32, further comprising retrieval of at least an element or an attribute of the document by the online pharmacy website via implementation of an extensible markup language configuration access protocol application usage at the online pharmacy website.

34. The apparatus of claim 20, further comprising initiating a transaction with an online pharmacy website, wherein the online pharmacy website sends a session initiation protocol SUBSCRIBE request to the electronic device addressing at least one of an element or attribute of the document being monitored.

35. The apparatus of claim 34, further comprising sending the at least one of the element or attribute to the online pharmacy website in a session initiation protocol NOTIFY request.

36. The apparatus of claim 20, wherein the electronic device is further configured to periodically synchronize the document with medical-related information stored with an authorized servicing entity.

37. The apparatus of claim 20, wherein the document comprises an extensible markup language document.

38. The apparatus of claim 20, wherein the creating, storing, and transmitting processes are implemented by computer code embodied on a computer-readable medium.

39. The apparatus of claim 20, wherein the creating, storing, and transmitting processes are implemented by a chipset of the electronic device.

40. An apparatus, comprising:
means for creating a document containing medical-related information at the apparatus;
means for storing the document at the apparatus; and
means for transmitting the document from the apparatus.

41. The apparatus of claim 40, further comprising means for storing, in addition to or instead of the medical-related information, personal information associated with a user of the electronic device, wherein the personal information includes non-credentials information to be transmitted in the document to a relevant entity, and wherein the apparatus comprises a mobile device.
